(19) United States
(12) Patent Application Publication
(10) Pub. No.: US 2008/0313844 A1
(43) Pub. Date: Dec. 25, 2008

(54) Blade Components Fitting System

(75) Inventor: Marc Nacamuli, Sao Paulo (BR)

Correspondence Address: GROSSMAN, TUCKER, PERREAULT & PFLEGER, PLLC, 55 SOUTH COMMERICAL STREET, MANCHESTER, NH, 03101, US

(73) Assignee: ELETROMECANICA DYNA S/A., Sao Paulo (BR)

(21) Appl. No.: 12/100,049

(22) Filed: Apr. 9, 2008

(30) Foreign Application Priority Data
Jun. 22, 2007 (BR) PI0704580-8

(51) Int. Cl. B60S 1/04

(52) U.S. Cl. 15/250.351

(57) ABSTRACT

The present disclosure relates to a blade components fitting system that may include a central arch member, two secondary arch members and one or more hinging devices. The system may allow fitting between the profiles and slots to happen by pressure, with a little interference ensuring safe connection between the parts, preventing disassembly while a blade is operating.

The present disclosure refers to a fitting system for components of a blade of an automotive vehicle.

### BACKGROUND

Several devices that may be applied on windshield wiper blades are known in the art. However, an inconvenience in the application of these devices relates to adjusting the position of the wiping blade relative to a vehicle glass surface.

One of the difficulties found in applying the blades on vehicle windshields relates to the curvature of the windshields. The curvature of the windshield should be followed by the wiper blade all along a wiper mechanism course, so as to provide optimum system performance.

For mechanisms with a single hinge, there may be no perfect blade adjustment for the most curved portions of the windshield. This lack of adjustment may be due to the structural stiffness of the arm portion of cleaning mechanisms with a single hinged arm, resulting in loss of cleaning efficiency for that area of the windshield.

Two-hinged arms may also be used in windshield cleaning mechanisms. However, the difficulty found in these mechanisms may relate to a hinging accuracy between the arches of the system. The arches may simultaneously require a perfect adjustment between the arches (by eliminating undesired gaps) while allowing possible angular movement of the arches in relation to each other.

Some solutions have been developed that may solve the above mentioned inconveniences, such as patent P10003099-6, which discloses a hinging system between windshield wiper blade components, that may provide a perfect adjustment between the wiper blade and the vehicle windshield.

The system may include a combination of a relatively larger arch and a relatively smaller arch, isolated by a plastic joint and connected by a plastic axis and a coupling means. The system may further include hinging of the larger and smaller arches.

However, this blade may only be assembled in a production line and delivered assembled to a supplier, as the assembly requires expert labor.

### BRIEF DESCRIPTION OF DRAWINGS

FIG. 1 is a front view of a system consistent with the present disclosure;

FIG. 2 is a detailed view of a coupling between a central arch and a secondary arch, consistent with the present disclosure;

FIG. 3 is a perspective view of a swiveling joint being fitted into a hinging device, consistent with the present disclosure;

FIG. 4 is a detailed view of the swiveling joint to be fitted into the hinging device, consistent with the present disclosure;

FIG. 5 is a detailed view of the swiveling joint to be fitted into the secondary arch, consistent with the present disclosure;

FIG. 6 is a perspective view of the swiveling joint fitted into the hinging device, consistent with the present disclosure;

FIG. 7 is a perspective view of the secondary arch being fitted into the hinging device joint, consistent with the present disclosure;

FIG. 8 is a detailed view of the secondary arch being fitted into the hinging device joint, consistent with the present disclosure;

FIG. 9 is a detailed view of the secondary arch fitted into the hinging device joint, consistent with the present disclosure;

FIG. 10 is a perspective view of the swiveling joint being fitted into the secondary arch, consistent with the present disclosure;

FIG. 11 is a perspective view of the swiveling joint fitted into the secondary arch, consistent with the present disclosure;

FIG. 12 is a perspective view of the central arch being fitted into the secondary arch joint, consistent with the present disclosure;

FIG. 13 is a perspective view of the central arch fitted into the secondary arch joint, consistent with the present disclosure;

FIG. 14 shows detailed views of the joints, consistent with the present disclosure; and

FIG. 15 shows detailed views of the slots, consistent with the present disclosure.

### DETAILED DESCRIPTION

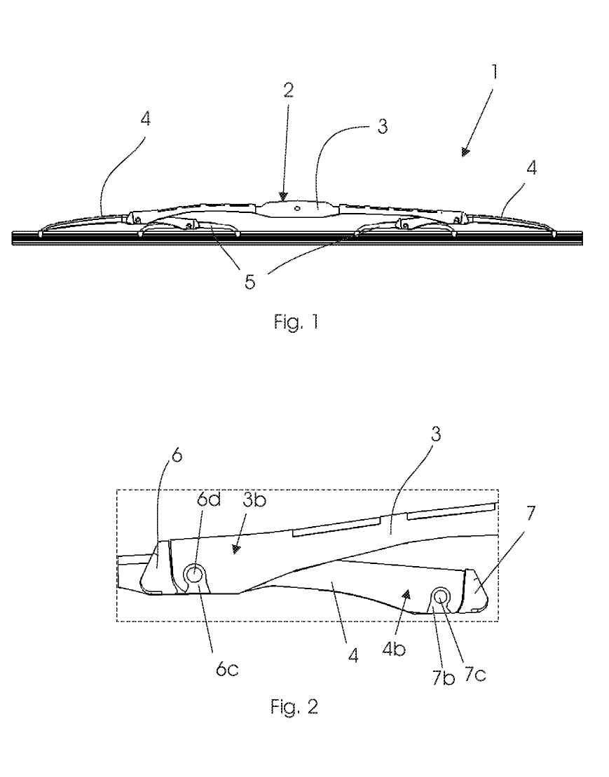

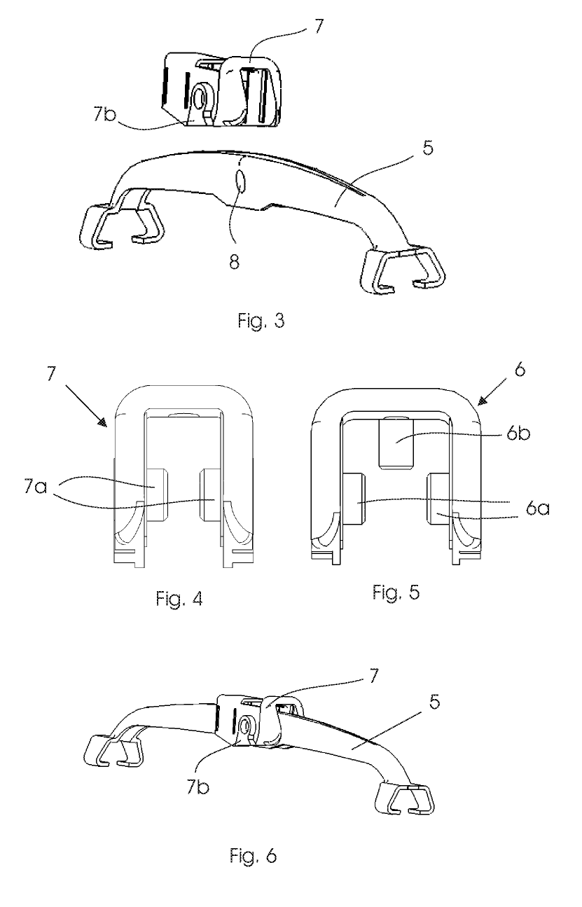

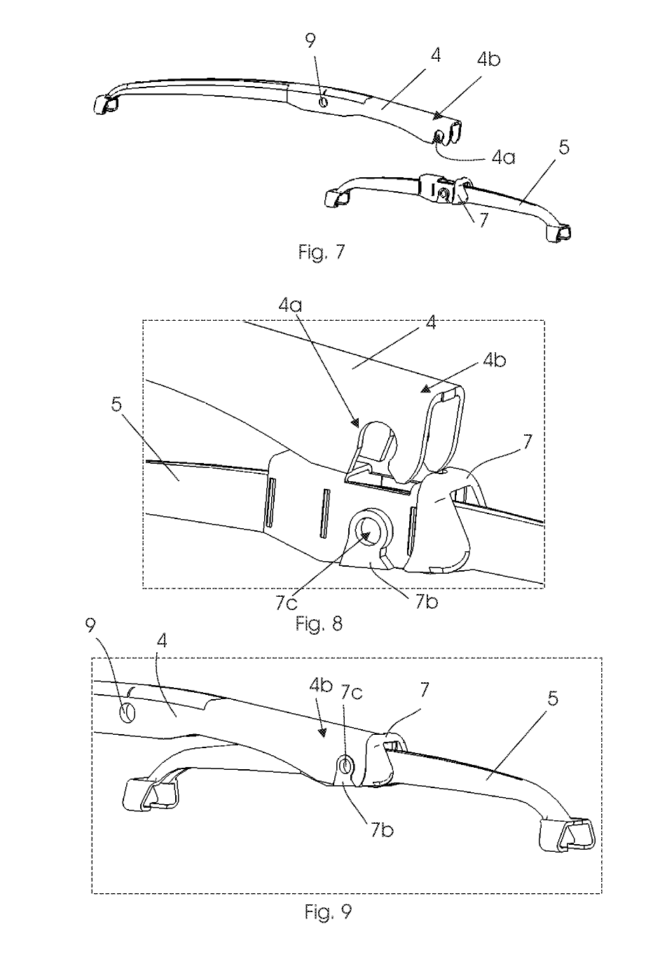

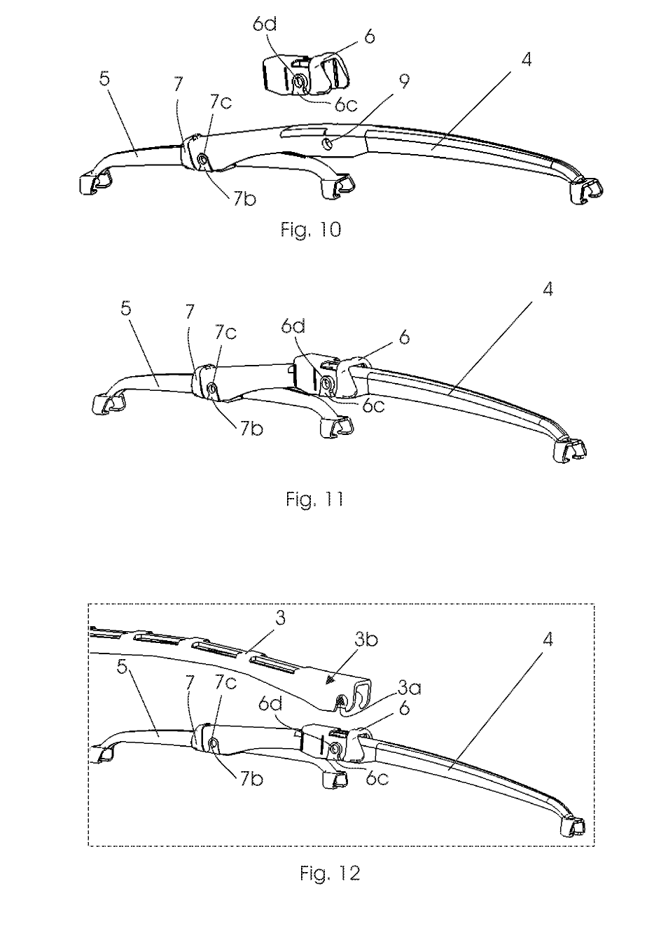

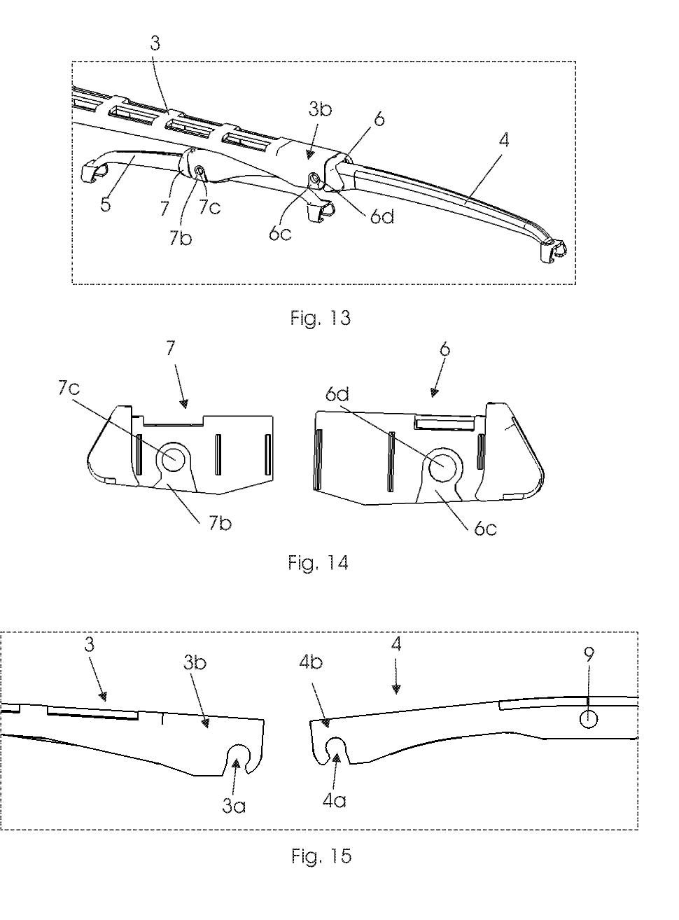

As may be seen from FIG. 1, a system 1 may include a blade 2 including a central arch member 3, two secondary arch members 4 and hinging devices 5.

A secondary arch member 4 may have a slot 4a disposed at or near one of its ends 4b.

The hinging device 5 may include a swiveling joint 7 preferably provided on its central portion, which includes one or more side pins 7a that may be inserted into holes 8 of the hinging device 5.

The swiveling joint 7 may include one or more external profiles 7b with a shape that corresponds to slot 4a of a secondary arch member 4, which may fit together with minimal or no gaps, thus providing hinging between hinging device 5 and a secondary arch 4.

The fit between an external profile 7b and a slot 4a may occur by an application of pressure. A small amount of interference between a profile 7b and a slot 4a may provide a safe connection between the parts, preventing disassembly while blade 2 is operating.

In the fitting process, joint 7 plastic material may be compressed to facilitate coupling to hinging device 5. Profiles 7b of joint 7 are provided with a central hole 7c for this purpose.

A secondary arch 4 may be similarly fitted to the central arch 3 as will be explained below.

As may be seen from FIG. 12, the central arch member 3 may have slots 3a disposed at or near arch 3b. The secondary arch 4 may be fitted to each end 3b, as will be explained below.

A secondary arch 4 may include a swiveling joint 6 preferably provided on its central portion, and having internal side pins 6a for fitting into orifices 9 on secondary arches 4. The swiveling joint 6 may further include an internal upper pin 6b for guiding and positioning joint 6, and which may not be fitted to the opposite position. Accordingly, secondary arch 4 may not be fitted into central arch 3 by mistake.

The joint 6 may include an external profile 6c with a shape that fits into slots 3a of central arch 3, which may fit together with minimal or no gaps, thus providing hinging between central arch 3 and secondary arches 4.

The fitting between profile 6c and slots 3a may occur by an application of pressure. A small amount of interference between a profile 6c and a slot 3a may provide a safe connection between the parts, preventing disassembly while blade 2 is operating.

In the fitting process, joint 6 plastic material may be compressed to facilitate coupling secondary arch 4. Profiles 6c of joint 6 may be provided with a central hole 6d for this purpose.

One advantage of the blade component fitting system is that the construction of all elements in system 1 and their respective fittings may prevent assembly by mistake, due to a series of guides and locks, as described in the present disclosure.

Further, the fitting between joints 6, 7 and arches 3, 4, may increase the assembly strength, preventing them from getting loose when subjected to opposite forces.

The present disclosure may be characterized by its fitting system 1, which maintains the same working functions in the vehicles as the previous model. Its differential and great advantage may be the relative ease of assembly of components.

It will be observed that while the above has been described as an illustrative example of this disclosure, all other changes and variations made to this disclosure, as it should be apparent to those skilled in the art, are considered within the wide scope and field of action of this disclosure, according to the attached claims.

1. A system comprising:
a central arch member;
two secondary arch members, each rotatably coupled at an end of said central arch member; and
one or more hinging devices rotatably coupled at an end of each secondary arch member, wherein each of said couplings is provided by an application of pressure, between a profile and a slot, wherein a small amount of interference between a profile and a slot provides a safe connection between the parts, preventing disassembly while the blade is operating.

2. The system of claim 1, wherein each secondary arch member has a slot disposed at or near an end.

3. The system of claim 2, further comprising a swiveling joint provided on a central portion of each said hinging device wherein said swiveling joint has one or more guide pins for fitting into one or more holes in said hinging device.

4. The system of claim 3, wherein said swiveling joint has one or more external profiles for fitting to the slot in the secondary arch member.

5. The system of claim 4 wherein said external profiles of said swiveling joint have a central hole.

6. The system of claim 1 wherein said central arch member has slots disposed on or near its ends, wherein said secondary arch members are fitted into said slot.

7. The system of claim 6 further comprising a swiveling joint provided on a central portion of each said secondary arch member wherein said swiveling joint has one or more guide pins for fitting into one or more holes in said secondary arch member and an internal upper pin for guiding and positioning said swiveling joint.

8. The system of claim 7, wherein said swiveling joint has external profiles with shape fitting to slots on said central arch member.

9. The system of claim 8, wherein said profiles of said swiveling joint have a central hole.
